(19) United States
(12) Patent Application Publication
(10) Pub. No.: US 2015/0074591 A1
(43) Pub. Date: Mar. 12, 2015

(54) HANDS-FREE SCROLLING OF DISPLAY CONTENT

(71) Applicant: Lenovo (Singapore) Pte. Ltd., Singapore (SG)

(72) Inventor: Corinna Paine Proctor, Raleigh, NC (US)

(73) Assignee: Lenovo (Singapore) Pte. Ltd., Singapore (SG)

(21) Appl. No.: 14/022,807

(22) Filed: Sep. 10, 2013

(51) Int. Cl. G06F 3/0485

(52) U.S. Cl. CPC G06F 3/0485
USPC 715/784

(57) ABSTRACT

An aspect provides a method, including: displaying content on a display screen of an information handling device; detecting, at the information handling device, a trigger for entering into a slow scrolling mode; and automatically scrolling, using a processor of the information handling device, the content on the display screen in the slow scrolling mode; said slow scrolling mode being a mode wherein the content is scrolled to present different content on the display screen; wherein the slow scrolling mode scrolling speed is adjustable without further user input. Other aspects are described and claimed.

### BACKGROUND

Information handling devices (“devices”), for example laptop and desktop computers, smart phones, e-readers, etc., are often used in a context where users view content on-screen that must be scrolled in some direction. For example, a user may load a web page or text document, e.g., to read or review its contents, onto a device display screen. If the content does not all fit within one display screen, the user must scroll or reposition the content.

Therefore, due to the nature of content and/or the physical dimensions of the devices, the user ends up repositioning or scrolling the content on the display screen. This is quite common in devices that have smaller display screens, e.g., smart phones and tablets. To scroll the content, the user provides manual inputs, e.g., via a touch screen, to reposition the content on the display. Depending on the content and/or the physical dimensions of the device, a user may need to make many scrolling movements.

### BRIEF SUMMARY

In summary, one aspect provides a method, comprising: displaying content on a display screen of an information handling device; detecting, at the information handling device, a trigger for entering into a slow scrolling mode; and automatically scrolling, using a processor of the information handling device, the content on the display screen in the slow scrolling mode; said slow scrolling mode being a mode wherein the content is scrolled to present different content on the display screen; wherein the slow scrolling mode scrolling speed is adjustable without further user input.

Another aspect provides an information handling device, comprising: a display screen; one or more processors; a memory device accessible to the one or more processors and storing code executable by the one or more processors to: display content on the display screen; detect a trigger for entering into a slow scrolling mode; and automatically scroll the content on the display screen in the slow scrolling mode; said slow scrolling mode being a mode wherein the content is scrolled to present different content on the display screen; wherein the slow scrolling mode scrolling speed is adjustable without further user input.

A further aspect provides a program product, comprising: a storage device having computer readable program code stored therewith, the computer readable program code comprising: computer readable program code configured to display content on a display screen of an information handling device; computer readable program code configured to detect, at the information handling device, a trigger for entering into a slow scrolling mode; and computer readable program code configured to automatically scroll, using a processor of the information handling device, the content on the display screen in the slow scrolling mode; said slow scrolling mode being a mode wherein the content is scrolled to present different content on the display screen; wherein the slow scrolling mode scrolling speed is adjustable without further user input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for hands-free scrolling of content.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While reading or viewing content on a display screen (e.g., on a smart phone or tablet, etc.), such as while reading an article or checking a social networking news feed, content is quite often static in nature and does not all fit onto the display. Consequently, the user must manually manipulate the content in order to scroll through it (i.e., bring new content into view or bring content into a different part of the screen). For example, the content requires a user to use a thumb or other digits to slowly move the screen content around so that the user can move more content into view.

This results in many micro-movements, which ultimately are frustrating and should be eliminated because of the extra work required in terms of user input to read the content. This is particularly so for text-based documents where continued scrolling in a single direction, e.g., to bring the contents at the bottom of the page to the center, are repeated at a somewhat regular rate. The problem becomes amplified with smaller screen devices, e.g., smart phones and tablet devices, where only a limited amount of content can appear on the screen at a given time.

Accordingly, an embodiment provides a trigger (that the user may elect to invoke or otherwise control) for entering a slow scrolling mode. When activated (e.g., via button press, via voice command, via gesture, etc.), the screen content starts to automatically scroll at a certain speed. The speed of the scroll may depend on the density of the content (e.g., slower scroll for denser content). When the screen begins to scroll the content in such a mode, it may remain active for a predetermined time, e.g., scrolling until the bottom of the page or the document is reached. The scrolling may stop and the system may wait for further user input. To exit the slow scrolling mode, the user may also manually provide input, e.g., via tap on the screen or click with a pointing device, which would take the system out of a slow scrolling mode. If the user happened to tap onto a hyperlink or linked content, the tap would be registered as typical behavior and the system would take the user to the tapped content.

The illustrated example embodiments will be best understood by reference to the figures. The following description is intended only by way of example, and simply illustrates certain example embodiments.

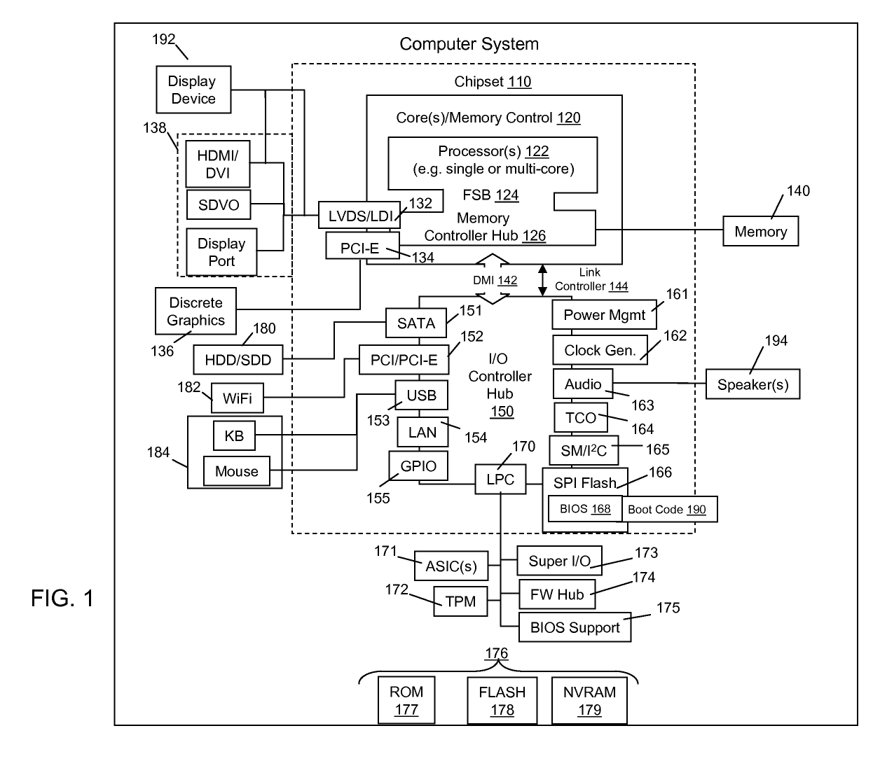

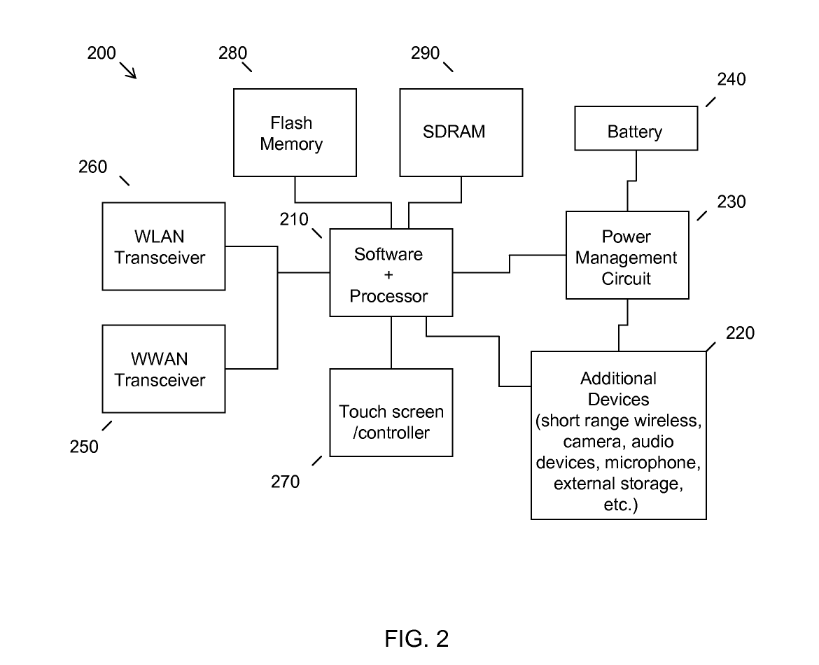

Referring to FIG. 1 and FIG. 2, while various other circuits, circuitry or components may be utilized in information handling devices, with regard to smart phone and/or tablet circuitry 200, an example illustrated in FIG. 2 includes a system on a chip design found for example in tablet or other mobile computing platforms. Software and processor(s) are combined in a single chip 210. Internal busses and the like depend on different vendors, but essentially all the peripheral devices (220) such as a camera may attach to a single chip 210. In contrast to the circuitry illustrated in FIG. 1, the circuitry 200 combines the processor, memory control, and I/O controller hub all into a single chip 210. Also, systems 200 of this type do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

System 200 typically includes one or more of a WWAN transceiver 250 and a WLAN transceiver 260 for connecting to various networks, such as telecommunications networks and wireless base stations. Commonly, system 200 will include a touch screen 270 for data input and display. System 200 also typically includes various memory devices, for example flash memory 280 and SDRAM 290.

FIG. 1, for its part, depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may be used to view content on a display screen. In the following non-limiting examples, smaller devices, e.g., tablets and smart phones, are described; however, these are only used for ease of description and the claimed embodiments are not so limited.

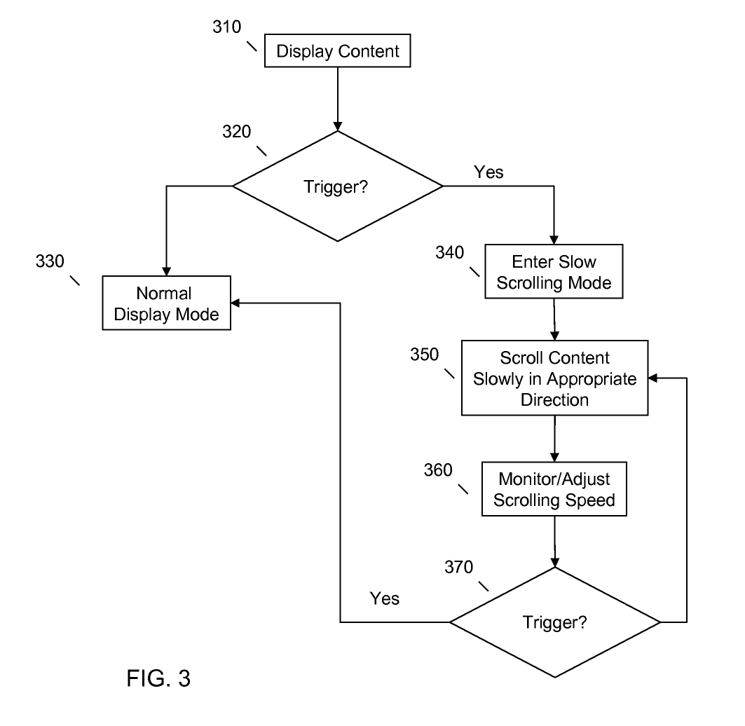

In FIG. 3 an example method of hands-free scrolling is illustrated. At the outset, a device such as a smart phone or tablet may be used to display content on a suitable display device, e.g., a touch screen such as touch screen 270. The content may take a variety of forms, e.g., web site content having text or text and images, a word processing document, a “PDF” document, etc. An embodiment will utilize one or more triggers to implement automatic scrolling.

Thus, an embodiment determines if a trigger for automatic scrolling has been detected at 320. If no such trigger is detected at 320, an embodiment may maintain a normal display mode at 330, i.e., one in which automatic scrolling is not implemented. However, if a trigger is detected at 320, an embodiment may enter slow scrolling mode at 340.

The trigger or triggers for entering slow scrolling mode may take a variety of forms. In one embodiment, a trigger may comprise user input, e.g., a tap, gesture, audio input, or sequence and/or combination thereof, etc. In another embodiment, an embedded trigger, e.g., included in web page content or derived from data associated with the web page, including data in the web page itself, may be utilized by an embodiment. Thus, an embodiment may await user input at 320 or utilize an automated mechanism to detect a trigger. It should be noted here that although the steps in FIG. 3 are ordered in an example fashion, certain steps may take place in a different order. For example, an embodiment may detect a trigger for entering the slow scrolling mode prior to displaying the content on the display screen.

Once an embodiment has entered the slow scrolling mode at 340, the contents of the screen will be scrolled slowly, e.g., at a rate determined to be appropriate for viewing the content. Therefore, in an embodiment, the content may be scrolled in an appropriate direction at 350, for example from top to bottom (of the content), noting that “top” and “bottom” may be reoriented if the device, e.g., smart phone, tablet, etc., is itself reoriented. An embodiment may detect such reorientation utilizing an accelerometer or other mechanism(s) such that the scrolling direction is maintained in a consistent fashion, e.g., for reading a text document.

In an embodiment, the scrolling speed of the slow scrolling mode may be monitored and/or the scrolling speed may be adjusted appropriately and 360. For example, an embodiment may wait a predetermined time after entering the slow scrolling mode or detecting a trigger prior to scrolling the contents of the screen. As another example, the scrolling of contents may be interrupted or paused, e.g., based on user input or automatically, such as when the device and screen contents are reoriented.

Moreover, an embodiment may adjust the scrolling speed based on the underlying content of the document. For example, in a dense document, e.g., one which contains a large amount of text in a small display area, e.g., as determined by a high word count in the display area or per page, etc., an embodiment may reduce the scrolling speed accordingly such that the user is afforded more time to read the content as it is scrolled slowly on screen. The same may be implemented for embedded objects, e.g., pausing on pictures or embedded videos and/or hyperlinks and thus affording the user additional time to review and/or interact with these elements of the content. The opposite is also possible, for example an embodiment may speed up or even “jump” through displayable content, e.g., a page bottom margin.

The user need not be bound by the automatic slow scrolling mode. Thus, similar to the monitoring or detecting of a trigger to enter the slow scrolling mode at 320, an embodiment may monitor or detect a trigger to exit the slow scrolling mode at 370. The trigger to exit the slow scrolling mode may be the same or different from the trigger for entry into the slow scrolling mode. Moreover, the slow scrolling mode exit trigger detected at 370 may act to simply pause the slow scrolling mode for a predetermined time. For example, if a user is viewing a first web page in a first slow scrolling mode and clicks on a hyperlink to another web page, this may act as a trigger to exit or pause the slow scrolling mode. If an exit, the new web page will not automatically enter the slow scrolling mode unless the entry trigger is detected at 320 (for the new web page). Alternatively, an embodiment may treat the trigger 370 as a pause in this context, re-entering or re-starting the slow scrolling mode a predetermined time after the new web page content is loaded on screen.

As can be appreciated from the foregoing, the various embodiments provide mechanisms to automatically enter a slow scrolling mode in which the user can enjoy a hands-free scrolling of content. This unburdens the user from being required to repeated manually enter inputs to reposition content. The various embodiments also provide mechanisms to ensure that the slow scrolling mode is appropriately adjusted and/or exited such that the user's expectations and desires for content viewing are met.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
displaying content on a display screen of an information handling device;
detecting, at the information handling device, a trigger for entering into a slow scrolling mode; and
automatically scrolling, using a processor of the information handling device, the content on the display screen in the slow scrolling mode;
said slow scrolling mode being a mode wherein the content is scrolled to present different content on the display screen;
wherein the slow scrolling mode scrolling speed is adjustable without further user input.

2. The method of claim 1, wherein the different content is new content.

3. The method of claim 2, wherein the slow scrolling mode scrolling speed is adjusted automatically based on density of the content displayed on the display screen.

4. The method of claim 3, wherein the density of the content displayed on the display screen is ascertained via determining text density of the content.

5. The method of claim 4, wherein the text density is associated with a word count of the content displayed on the display screen.

6. The method of claim 4, wherein the speed of the slow scrolling mode is adjusted downward responsive to determining the text density of the content is above a predetermined threshold.

7. The method of claim 1, wherein the trigger for entering into the slow scrolling mode is selected from the group of triggers consisting of a user input trigger and a trigger derived from data associated with the content displayed on the display screen.

8. The method of claim 1, wherein the content displayed on the display screen is selected from the group of content consisting of web site content, and word processing document content.

9. The method of claim 1, further comprising detecting a trigger for exiting out of the slow scrolling mode.

10. The method of claim 7, wherein the trigger for exiting out of the slow scrolling mode comprises a user input trigger.

11. An information handling device, comprising:
a display screen;
one or more processors;
a memory device accessible to the one or more processors and storing code executable by the one or more processors to:
display content on the display screen;
detect a trigger for entering into a slow scrolling mode; and
automatically scroll the content on the display screen in the slow scrolling mode;
said slow scrolling mode being a mode wherein the content is scrolled to present different content on the display screen;
wherein the slow scrolling mode scrolling speed is adjustable without further user input.

12. The information handling device of claim 11, wherein the different content is new content.

13. The information handling device of claim 12, wherein the slow scrolling mode scrolling speed is adjusted automatically based on density of the content displayed on the display screen.

14. The information handling device of claim 13, wherein the density of the content displayed on the display screen is ascertained via determining text density of the content.

15. The information handling device of claim 14, wherein the text density is associated with a word count of the content displayed on the display screen.

16. The information handling device of claim 14, wherein the speed of the slow scrolling mode is adjusted downward responsive to determining the text density of the content is above a predetermined threshold.

17. The information handling device of claim 11, wherein the trigger for entering into the slow scrolling mode is selected from the group of triggers consisting of a user input trigger and a trigger derived from data associated with the content displayed on the display screen.

18. The information handling device of claim 11, wherein the content displayed on the display screen is selected from the group of content consisting of web site content, and word processing document content.

19. The information handling device of claim 11, wherein the code is further executable by the one or more processors to detect a trigger for exiting out of the slow scrolling mode.

20. A program product, comprising:
a storage device having computer readable program code stored therewith, the computer readable program code comprising:
computer readable program code configured to display content on a display screen of an information handling device;
computer readable program code configured to detect, at the information handling device, a trigger for entering into a slow scrolling mode; and
computer readable program code configured to automatically scroll, using a processor of the information handling device, the content on the display screen in the slow scrolling mode;
said slow scrolling mode being a mode wherein the content is scrolled to present different content on the display screen;
wherein the slow scrolling mode scrolling speed is adjustable without further user input.
